(19) United States
(12) Patent Application Publication
(10) Pub. No.: US 2010/0316248 A1
(43) Pub. Date: Dec. 16, 2010

(54) SELF-COOLING LOUDSPEAKER

(75) Inventor: Jose Martinez-Iranzo, Moncada (ES)

Correspondence Address: YOUNG & THOMPSON, 209 Madison Street, Suite 500, Alexandria, VA, 22314, US

(73) Assignees: Jose MARTINEZ IRAZNO, Moncada (ES); ACUSTICA BEYMA, SL, Moncada (ES)

(21) Appl. No.: 12/866,787

(22) PCT Filed: Feb. 12, 2009
(86) PCT No.: PCT/ES2009/000083

§ 371 Date: Aug. 9, 2010

(30) Foreign Application Priority Data
Mar. 5, 2008 (ES) P200800649

(51) Int. Cl. H04R 9/06

(52) U.S. Cl. 381/397

(57) ABSTRACT

An improved self-cooling loudspeaker of the electrodynamic type, formed by a magnetic circuit includes a cylindrical permanent magnet (1) and two polar parts (2 and 3), namely a cylindrical “core ring” (2) positioned on the permanent magnet (1) and a “return vessel” (3) having a circular plan view, on which the permanent magnet (1) is placed. The “core ring” (2) includes a plurality of helical grooves (4) on the outer cylindrical face thereof, while the “return vessel” (3) also includes a plurality of helical grooves (5) on the upper part of the inner cylindrical face thereof, matching the grooving (4) of the “core ring” (2).

### TECHNICAL FIELD OF THE INVENTION

The object of the present invention, as expressed in the title of this specification, relates to an electrodynamic-type self-cooling loudspeaker, although optionally, it may also be any other type of loudspeaker.

### BACKGROUND OF THE INVENTION

In principle, an electrodynamic loudspeaker consists of a mobile electric coil disposed in the circular air gap of a closed, permanent and fixed magnetic circuit. When an alternating electric current passes through the coil, alternating electric forces in accordance with said alternating current are generated in said coil; said forces make the coil vibrate (by virtue of its mobility) and transmit said vibrations, either to a membrane or to an acoustic screen whereto it is attached, thereby generating the sound which is transmitted to the surrounding air.

Generally speaking, the magnetic circuit of a loudspeaker consists of, at least, three basic elements: a cylindrical permanent magnet and two polar parts. One of these (the upper polar part) is a cylindrical “core ring” having temporary magnetism (manufactured from “soft” iron or similar) disposed on the permanent magnet, while the other (the lower polar part) is a “return valve” (in charge of closing the magnetic circuit) having a circular base, whereon the permanent magnet is in turn disposed. In this case, the air gap which houses the mobile coil is the circular space left between the outer cylindrical face of the “core ring” and the upper part of the inner cylindrical face of the “return valve.”

Normally, the electrical energy consumed by a loudspeaker depends on the current circulating through its coil, which in turn depends, in the broad sense, on loudspeaker impedance and, specifically, on the electrical resistance of its coil. Ideally, all the electrical energy that reaches the loudspeaker should be transformed into acoustic energy, but this does not occur as most of said energy is transformed into heat; said heat, generated within the mobile coil itself, is a consequence of the Joule effect due to the passage of the electric current through the turns of said coil.

The heat generated causes two negative effects in the loudspeaker.

Firstly, the heating of the coil produces an increase in the electrical resistance of its turns (by virtue of the positive temperature coefficient of the metals from which it is usually manufactured), which causes a decrease in electrical intensity and, therefore, in the power that reaches the loudspeaker. This causes a decrease in loudspeaker sound level which is known as “power compression-induced loss.”

Secondly, if the heating is excessive, in addition to the previous effect there can be a second and worse effect which consists of the possibility that the coil may burn, rendering the loudspeaker useless.

Evacuation of this heat is normally carried out through natural transfer due to temperature gradient from the coil to the fixed components near it (i.e. towards the polar parts of the permanent magnet) through the air gap; finally, the heat passes from said parts and/or from the permanent magnet towards the exterior to the atmosphere. Therefore, it is a relatively low-speed passive heat transfer, due to the relatively low thermal conductivity of the iron and other ferromagnetic materials, which are normally used in the manufacture of the constituent elements of the magnetic circuit of the loudspeaker.

In order to avoid the drawback represented by the accumulation of heat in the coil and the two aforementioned negative effects entailed, some more advanced models have vertical notches or slots on the outer cylindrical face of the “core ring”, which allow vertical circulation of air between the mobile coil and the “core ring.”

However, this procedure is not very effective and barely increases heat evacuation capacity compared to other, more traditional loudspeaker models.

### DESCRIPTION OF THE INVENTION

The novel improved self-cooling loudspeaker that is the object of the present technical specification has been designed for the purpose of overcoming the aforementioned drawbacks.

Generally speaking, the present invention relates to a new loudspeaker model which, having self-cooling capacity, allows increases in power of at least 35% compared to other models with similar features, quality and price.

The new loudspeaker is manufactured in such a manner that its magnetic circuit has a spiral grooving in the air gap on either side of the mobile coil. The oscillating movement of the coil itself, transmitted to the “dust cap” of the acoustic membrane, acts as a reciprocating pump that impels the forced cooling air; therefore, said forced air is made to circulate back and forth along the interior of a cooling system of which the spiral grooving of the air gap forms part.

In this manner, the cooling of the mobile coil is much more effective, as the cooling air, forced to circulate around the coil and on either side thereof, along the interior of the spiral grooves, is directly in contact therewith for a much longer period of time; therefore, heat transfer by contact between the cooling air and the coil is much more efficient.

In essence, the new loudspeaker has a magnetic circuit composed of three basic elements: a cylindrical permanent magnet and two polar parts, upper and lower; the upper polar part is a cylindrical “core ring” having a spiral grooving on its outer cylindrical face; said “core ring” is disposed on the permanent magnet; the lower polar part is a “return valve” (in charge of closing the magnetic circuit) having a circular base and a spiral grooving on the upper part of its inner cylindrical face, coincident with the grooving of the “core ring”; in turn, the permanent magnet is disposed on the “return valve.”

In this manner, the air gap, which houses the mobile coil, is the spirally grooved circular space left between the outer cylindrical face of the “core ring” and the upper part of the inner cylindrical face of the “return valve.”

The “core ring” also has a central pass-through orifice which, in addition to serving as an additional cooling orifice, also serves to alleviate the excessive compression that could occur (in the case of vibrations caused by loud sounds) between the “core ring” and the “dust cap” of the membrane, as said compression is counterproductive to some loudspeaker elements.

Optionally, the “core ring” has additional cooling pass-through orifices.

### DESCRIPTION OF THE DRAWINGS

With the object of illustrating the foregoing, a set of drawings has been included as an integral part of the present specification, wherein a solely explanatory but non-limiting example of practical embodiment of the characteristics of the novel invention has been represented in a simplified and schematic manner:

FIG. 1 shows a side and exploded view of the different constituent elements of the novel loudspeaker, wherein a cross-section of the “return valve”, coil, membrane and “dust cap” attached thereto can be observed;

FIG. 2 shows the magnetic circuit assembled, but separated from the coil and its screen;

FIG. 3 shows all the elements assembled in their final positions; it also shows the cooling outgoing air flow during the movement of the screen towards the magnet; during the reverse movement of the screen, the air flow would be the contrary, i.e. incoming; and

FIGS. 4 and 5 show a plan and side view, respectively, of the “core ring.”

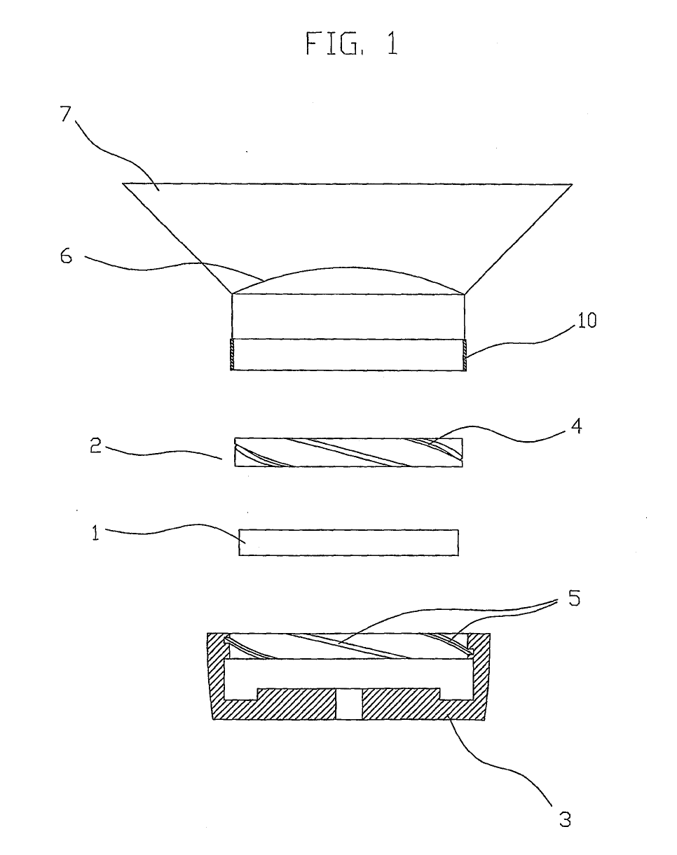

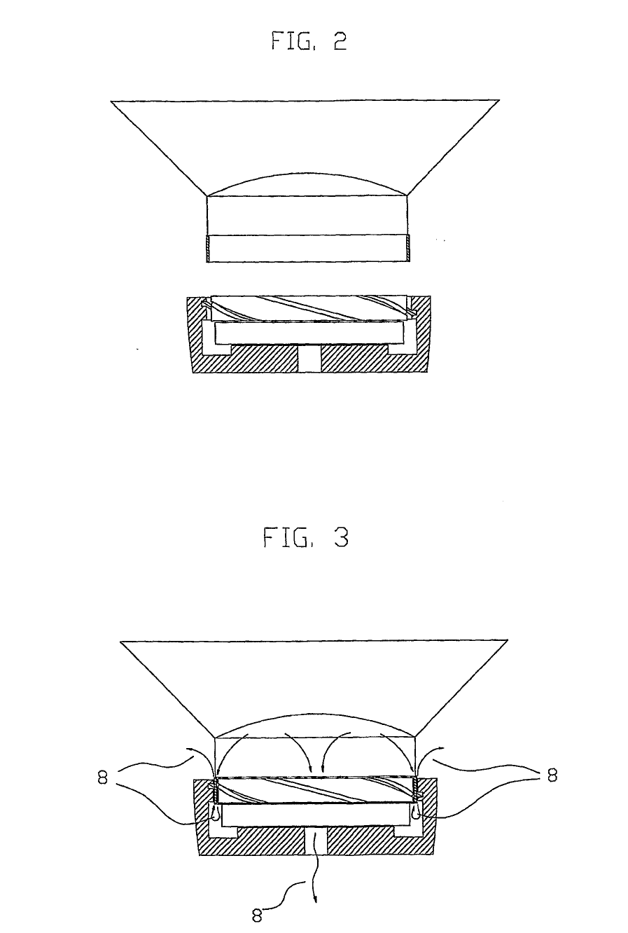

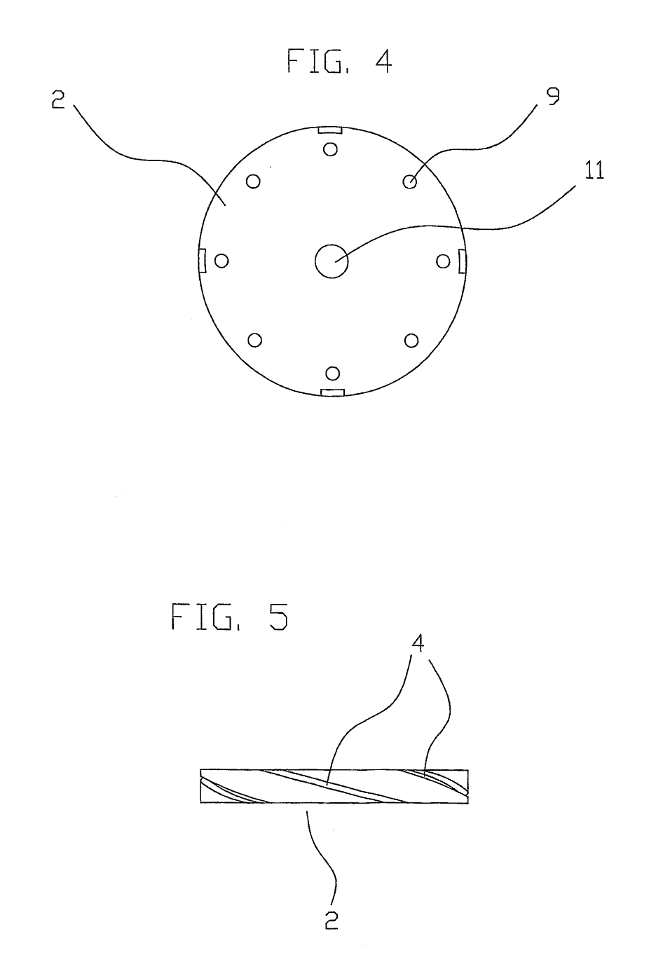

### DESCRIPTION OF A PRACTICAL EXAMPLE

A practical embodiment of the device that is the object of the present specification is described, by way of example, in the attached figures.

The new improved self-cooling loudspeaker, of the electrodynamic type, consists of a magnetic circuit composed of a cylindrical permanent magnet (1) and two polar parts (2 and 3), one of which is a cylindrical “core ring” (2) disposed on the permanent magnet (1), while the other polar part is a “return valve” (3) having a circular base, whereon the permanent magnet (1) is in turn disposed.

The novel loudspeaker is characterised in that the “core ring” (2) has a plurality of spiral grooves (4) on its outer cylindrical face, while the “return valve” (3) also has a plurality of spiral grooves (5) on the upper part of its inner cylindrical face, coincident with the grooving (4) of the “core ring” (2).

The coil (10) is housed within the air gap constituted between the outer cylindrical face of the “core ring” (2) and the inner cylindrical face of the “return valve.”

The oscillating movement of the coil (10) itself, transmitted to the “dust cap” (6) of the membrane (7), is used as a reciprocating pump for impelling the forced cooling air (8) back and forth.

The “core ring” (2) has additional cooling pass-through orifices (9) and also has a central pass-through orifice (11) which, in addition to serving as an additional cooling orifice, also serves to alleviate the excessive compression waves that could occur between the “core ring” (2) and the “dust cap” (6) of the membrane (7), as said excessive compression is counterproductive to some loudspeaker elements.

The materials used to manufacture the different constituent elements of the present invention shall be independent of the object thereof, in addition to the shapes, dimensions and accessories thereof, and may be replaced by other technically equivalent materials, provided that they do not affect the essentiality of the invention nor differ from the scope defined in the claims section.

Having established the expressed concept, the claims are expounded below, thereby summarising the novelties being claimed:

1. Electrodynamic-type improved self-cooling loudspeaker consisting of a magnetic circuit composed of a cylindrical permanent magnet (1) and two polar parts (2 and 3), one of which is a cylindrical “core ring” (2) disposed on the permanent magnet (1), while the other polar part is a “return valve” (3) having a circular base, whereon the permanent magnet (1) is in turn disposed, essentially characterised in that the “core ring” (2) has a plurality of spiral grooves (4) on its outer cylindrical face, while the “return valve” (3) also has a plurality of spiral grooves (5) on the upper part of its inner cylindrical face, coincident with the grooving (4) of the “core ring” (2).

2. Improved self-cooling loudspeaker, according to claim 1, characterised in that, optionally, the “core ring” (2) has additional cooling pass-through orifices (9).
